(19) United States
(12) Patent Application Publication
(10) Pub. No.: US 2022/0177983 A1
(43) Pub. Date: Jun. 9, 2022

(54) WATER SLOWLY-DISINTEGRATING HARDEN SUGAR, TABLEWARE EMPLOYING THE HARDEN SUGAR, AND METHODS OF MAKING AND USING SAME

(71) Applicant: DAHSHIARN CHIAO, Naperville, IL (US)

(72) Inventor: DAHSHIARN CHIAO, Naperville, IL (US)

(21) Appl. No.: 17/247,359

(22) Filed: Dec. 9, 2020

(51) Int. Cl. C13B 50/02; A47G 19/00; A47G 21/00; C13B 50/00; B29C 33/38; B29C 33/00

(52) U.S. Cl. CPC C13B 50/02; A47G 19/00; A47G 21/00; B29K 2995/0046; B29C 33/38; B29C 33/0022; B29K 2883/00; C13B 50/002

(57) ABSTRACT

A water-slowly-disintegrating harden sugar comprising a mixture of fructose, glucose, sucrose, sucrose substitute, water-soluble cellulose, and water-soluble cellulose derivatives is disclosed herein. Also disclosed are related tableware incorporating the water-slowly-disintegrating harden sugar, and related methods of making and using the water-slowly-disintegrating harden sugar.

### FIELD OF THE INVENTION

The present disclosure provides formulae and methods for making tableware incorporating the water-slowly-disintegrating harden sugar comprising a mixture of fructose, glucose, sucrose, sucrose substitute, water-soluble cellulose, and water-soluble cellulose derivatives.

### BACKGROUND

The present disclosure relates generally to water-slowly-disintegrating harden sugar useful for making environmental friendly tableware and making it when you want to use it. More particularly, the disclosure relates to methods of making and using the water-slowly-disintegrating harden sugar by on-demand making.

An alternative approach to environmental friendly tableware is the implementation of on-demand making of tableware. The rationale for using sugar as the material is based on the following facts that (i) sugar in natural; (ii) sugar is biodegradable; (iii) sugar is water soluble; (iv) sugar is eatable. However, sugar tableware should be able to endure the water and operation during the serving.

Thus, it is desirable to provide an on-demand making method for easily turn sugar into tableware.

### SUMMARY

The limitations of the prior art are overcome in methods of the present invention by providing devices and methods for contactless delivering pulsed electric fields in a A first aspect of the disclosure herein is a water-slowly-disintegrating harden sugar comprising a mixture of a mixture of fructose, glucose, sucrose, sucrose substitute, water-soluble cellulose, and water-soluble cellulose derivatives.

Another aspect of the disclosure herein is a method for making the tableware employing the water-slowly-disintegrating harden sugar comprising a mixture of a mixture of fructose, glucose, sucrose, sucrose substitute, water-soluble cellulose, and water-soluble cellulose derivatives.

For the sugar mixture, related articles, and methods described herein, optional features, including but not limited to components, compositional ranges thereof, substituents, conditions, and steps, are contemplated to be selected from the various aspects, embodiments, and examples provided herein.

Further aspects and advantages will be apparent to those of ordinary skill in the art from a review of the following detailed description, taken in conjunction with the drawings. While the water-slowly-disintegrating harden sugar and methods of making are susceptible of embodiments in various forms, the description hereafter includes specific embodiments with the understanding that the disclosure is illustrative, and is not intended to limit the invention to the specific embodiments described herein.

### BRIEF DESCRIPTION OF THE FIGURES

For further facilitating the understanding of the present invention, four drawing figures are appended hereto.

FIG. 1 depicts front and side views of an inner mold and outer mold configuration having a stretchable silicon configuration according to the disclosure herein.

FIG. 2 depicts front and side views of an inner mold and outer mold configuration having a controllable enlarged and reduced metal mechanical configuration according to the disclosure herein.

FIG. 3 depicts front and side views of an inner mold and outer mold configuration having a controllable enlarged and reduced metal mechanical configuration according to the disclosure herein.

FIG. 4 is a flowchart illustrating the steps associated with a method of making the tableware comprising water-slowly-disintegrating harden sugar, in accordance with the present invention.

### DETAILED DESCRIPTION OF THE PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

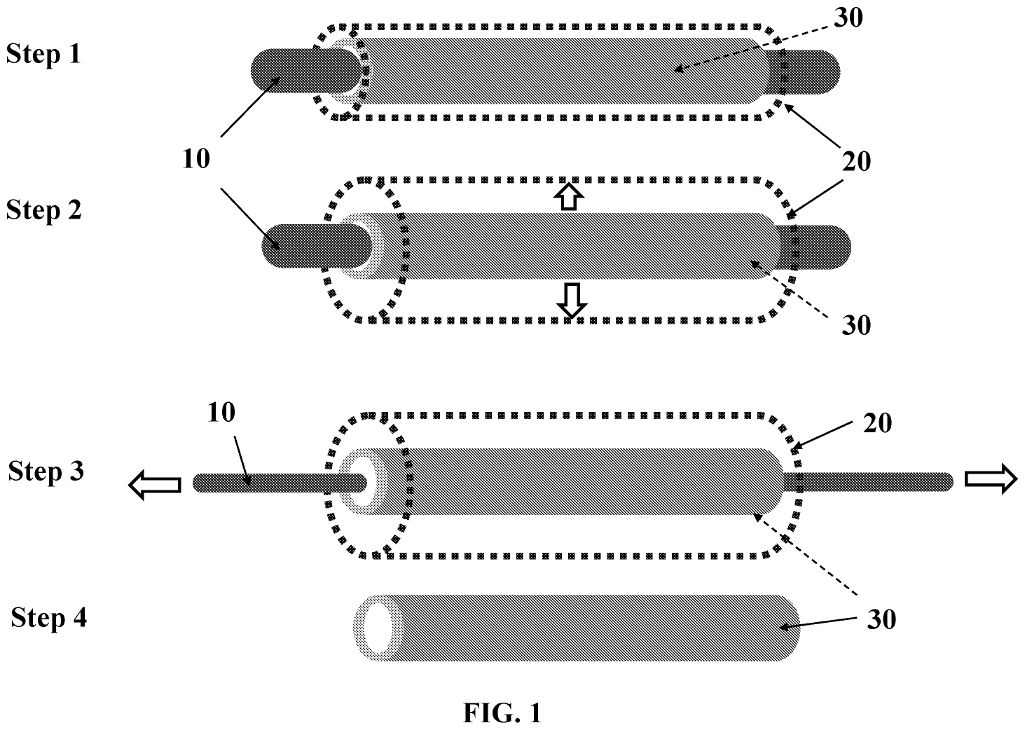

An inner mold and outer mold configuration made in accordance with the second preferred embodiments of the present invention is depicted in front and side views in FIG. 1. The inner mold configuration 10 mounted in fixed relation to the body of the outer mold configuration 20 and a melted sugar mixture 30 had been injected into the gap between the inner mold configuration 10 and the outer mold configuration 20 in STEP 1. The outer mold configuration 20 made of stretchable silicon will be dilated in order to detaching from a solidified sugar mixture 30 in STEP 2. The inner mold configuration 10 made of stretchable silicon will be contracted in order to detaching from a solidified sugar mixture 30 in STEP 3. Then a hollow shape harden sugar tube 30 will be released from the inner mold configuration 10 and the outer mold configuration 20 in STEP 4.

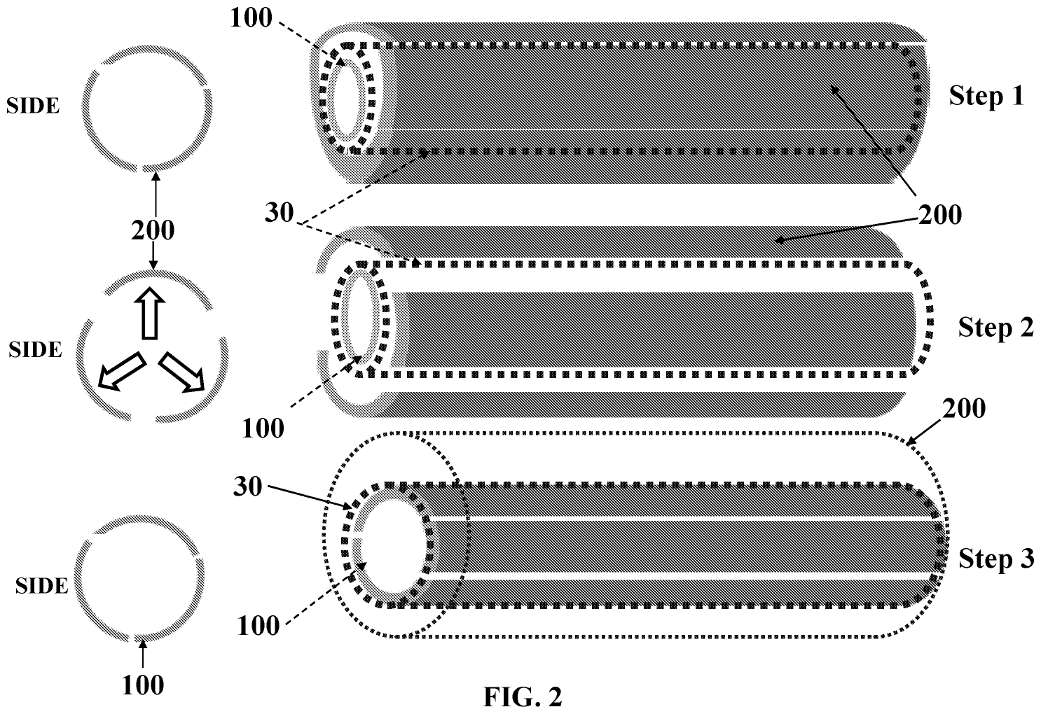

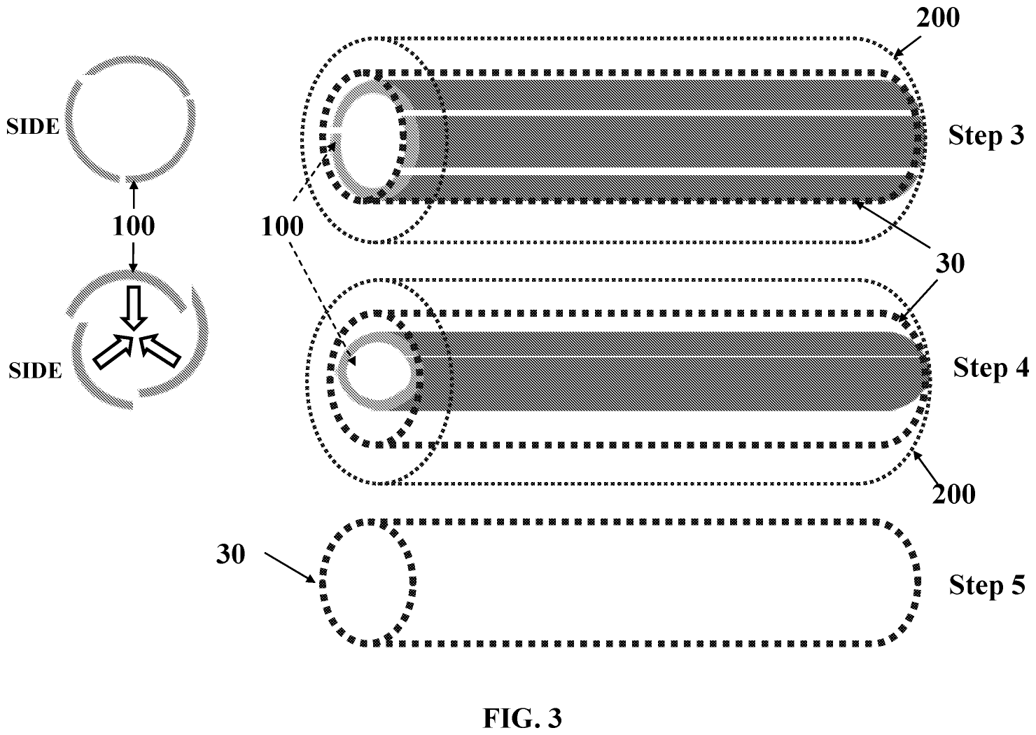

Another inner mold and outer mold configuration made in accordance with the second preferred embodiments of the present invention is depicted in front and side views in FIG. 2 and FIG. 3. The inner mold configuration 100 mounted in fixed relation to the body of the outer mold configuration 200 and a melted sugar mixture 30 had been injected into the gap between the inner mold configuration 100 and the outer mold configuration 200 in STEP 1. The outer mold configuration 20 made of controllable enlarged and reduced metal mechanical configuration will be dilated in order to detaching from a solidified sugar mixture 30 in STEP 2. The inner mold configuration 10 made of controllable enlarged and reduced metal mechanical configuration will be contracted in order to detaching from a solidified sugar mixture 30 in STEP 4. Then a hollow shape harden sugar tube 30 will be released from the inner mold configuration 100 and the outer mold configuration 200 in STEP 5.

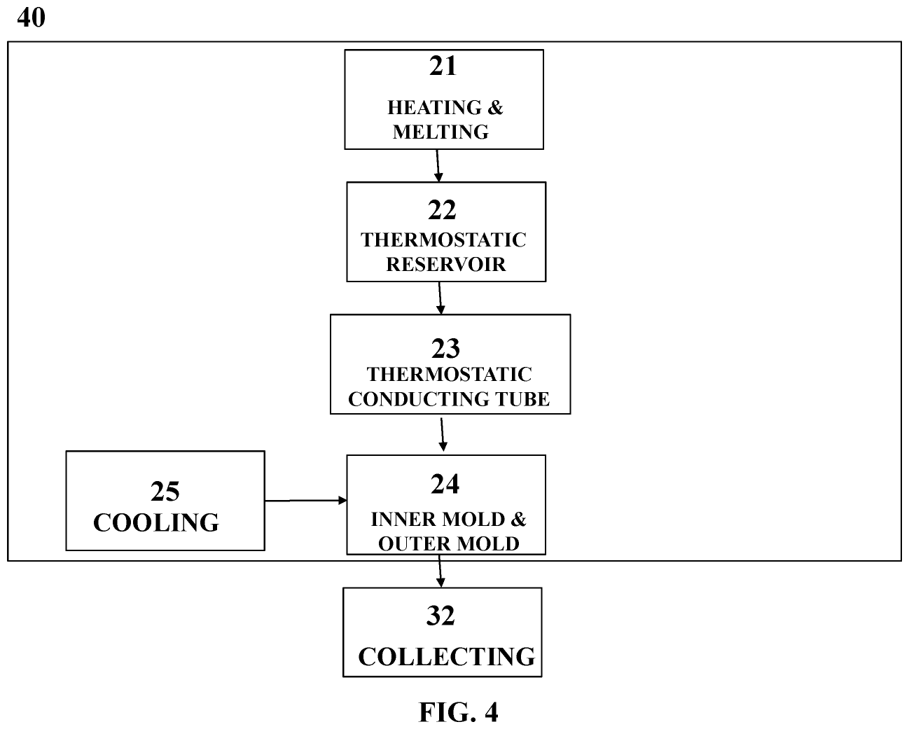

A sugar tableware making device 40 made in accordance with the second preferred embodiments of the present invention is depicted in a plan view in FIG. 4. The sugar tableware making device 40 generally includes a heating and meting configuration 21, configured to melt the sugar mixture in a temperature range of 170° C. to 300° C. The thermostatic reservoir configuration 22 then receives the co-melted sugar mixture from the heating and meting configuration 21 after the sugar mixture is melted. The thermostatic reservoir configuration 22 and thermostatic conducting tube configuration 23 will keep at temperature above 120° C. Upon the activation from a demand, the inner mold and outer mold configuration 24 then receives the melted sugar mixture in a controlled amount from the thermostatic reservoir configuration 22 and thermostatic conducting tube configuration 23. During the solidification process of a sugar mixture, a cooling configuration 25 will aid to accelerate the solidification process of a sugar mixture. Both the inner mold configuration 10 and the outer mold 20 configuration will start to detach itself from a solidified sugar mixture 30. A harden sugar 30 then will be released into the colleting configuration 32.

What is claimed is:

1. A water-slowly-disintegrating harden sugar comprising a mixture of a mixture of fructose, glucose, sucrose, sucrose substitute, water-soluble cellulose, and water-soluble cellulose derivatives, wherein (i) the water-soluble cellulose or water-soluble cellulose derivatives is present in an amount in a range of 1% to about 60% by dry weigh of the total amount of harden sugar; or (ii) the fructose, glucose, sucrose or sucrose substitute is present in an amount of at least 40% to about 99% by dry weigh of the total amount of harden sugar.

2. The water-slowly-disintegrating harden sugar of claim 1, wherein the sucrose substitute comprises Isomalt.

3. The water-slowly-disintegrating harden sugar of claim 1, wherein the water-soluble cellulose or water-soluble cellulose derivatives comprises Methyl Cellulose.

4. The water-slowly-disintegrating harden sugar of claim 1, wherein the water-soluble cellulose or water-soluble cellulose derivatives comprises Ethyl Hydroxyethyl Cellulose.

5. The water-slowly-disintegrating harden sugar of claim 1, wherein the mixture comprises one of fructose, glucose, sucrose or sucrose substitute with one of water-soluble cellulose or water-soluble cellulose derivatives.

6. The water-slowly-disintegrating harden sugar of claim 1, wherein the mixture is co-melted in a range of 170° C. to 300° C.

7. A method for making the tableware employing the water-slowly-disintegrating harden sugar comprising a mixture of fructose, glucose, sucrose, sucrose substitute, water-soluble cellulose, and water-soluble cellulose derivatives, wherein (i) the method comprises an inner mold and outer mold configuration for making the tableware; and (ii) the method comprises an thermostatic reservoir and conducting tube configuration for melted sugar mixture; and (iii) the method comprises an cooling system for accelerating the solidification of harden sugar.

8. The inner mold and outer mold of claim 7, wherein the inner mold configuration comprises stretchable plastic.

9. The inner mold and outer mold of claim 7, wherein the inner mold configuration comprises stretchable silicon.

10. The inner mold and outer mold of claim 7, wherein the inner mold configuration comprises controllable enlarged and reduced metal mechanical configuration.

11. The inner mold and outer mold of claim 7, wherein the inner mold configuration comprises controllable enlarged and reduced plastic mechanical configuration.

12. The inner mold and outer mold of claim 7, wherein the inner mold configuration comprises fixed metal configuration.

13. The inner mold and outer mold of claim 7, wherein the inner mold configuration comprises fixed plastic configuration.

14. The inner mold and outer mold of claim 7, wherein the outer mold configuration comprises stretchable plastic.

15. The inner mold and outer mold of claim 7, wherein the outer mold configuration comprises stretchable silicon.

16. The inner mold and outer mold of claim 7, wherein the outer mold configuration comprises controllable enlarged and reduced metal mechanical configuration.

17. The inner mold and outer mold of claim 7, wherein the outer mold configuration comprises controllable enlarged and reduced plastic mechanical configuration.

18. The inner mold and outer mold of claim 7, wherein the outter mold configuration comprises fixed metal configuration.

19. The inner mold and outer mold of claim 7, wherein the outter mold configuration comprises fixed plastic configuration.

20. The inner mold and outer mold of claim 7, wherein the temperature setting for thermostatic reservoir and conducting tube configuration is above 120° C.
